(19) United States
(12) Patent Application Publication
(10) Pub. No.: US 2025/0107667 A1
(43) Pub. Date: Apr. 3, 2025

(54) CHEF ROBOT DEVICE

(71) Applicant: Shin Fang Global CO., LTD., Taipei City (TW)

(72) Inventors: Teh San Sun, Taipei City (TW); Lee Fei Chen, Taipei City (TW); Chun Suil Lin, Taipei City (TW); Ju Chun Ko, Taipei City (TW)

(73) Assignee: Shin Fang Global CO., LTD., Taipei City (TW)

(21) Appl. No.: 18/376,173

(22) Filed: Oct. 3, 2023

(51) Int. Cl. A47J 44/00; A47J 36/32; B25J 9/00; B25J 9/16; B25J 11/00; B25J 19/02

(52) U.S. Cl. CPC A47J 44/00; A47J 36/32; B25J 9/0087; B25J 9/1664; B25J 11/008; B25J 19/02; B25J 19/021; A47J 2202/00

(57) ABSTRACT

A chef robot device includes a temperature sensing module, am image recognizing module, an odor detecting module, a central processing unit (CPU), and a robotic arm module. The temperature sensing module, the image recognizing module, and the odor detecting module respectively sense a temperature, a color, and an odor of foods in a cooker, and transmit a temperature sensing signal, a food color depth signal, and an odor concentration signal to the CPU. The CPU outputs motion instructions to the robotic arm module according to food statuses and a trajectory planning model. The robotic arm module performs motions for cooking the foods according to the motion instructions. The chef robot device can improve a food-cooking quality by training, and can resolve a problem of lacking experienced chefs.

### BACKGROUND OF THE INVENTION

### 1. Field of the Invention

The present invention relates to a cooking device, especially a chef robot device which can automatically cook food.

### 2. Description of the Related Art

Eating plays an essential part in people's daily life. People prepare meals by cooking foods, and then have the meal to obtain the daily nutrients that the human body needs, and some people even enjoy the cooking process. Although cooking food can provide many benefits, most modern people give up cooking after work due to the time and energy consumed by cooking. Moreover, some foods require complicated cooking processes, such that most modern people eat out or resort to food-delivery services.

Although various restaurants can provide various foods to meet the dining habits of most people, the restaurants face problems such as high talent turnover and long-term manpower shortages. Many restaurants lack experienced chefs, such that quality of the foods provided by the restaurants is unstable. Therefore, the restaurants may have difficulty retaining customers, and eventually go out of business. When the problems are not resolved, the restaurants will close down continuously, affecting options of food services. In order to resolve the problems of the high talent turnover and the long-term manpower shortages, food delivery robots are developed. The food delivery robots can assist food delivery staffs to deliver the food. For example, when the chef finishes cooking a meal, the chef can directly place the meal on the food delivery robot, and then the chef can simply input multiple operation instructions to instruct the food delivery robot to deliver the meal to a specific location. For example, the operation instructions may be a table number of the restaurant. Moreover, a noodle-making robot is also developed. The staff of the restaurant only need to put raw ingredients of noodles into the noodle-making robot, and then the noodle-making robot will make noodles.

However, the food delivery robot or the noodle-making robot can only perform identical and repeated motions. For the restaurant, although the robots can overcome some of the problems, the restaurants lack experienced chefs, such that the quality of the foods provided by the restaurants is still unstable. Therefore, the restaurants still have difficulty retaining customers, and eventually the restaurants may go out of business.

### SUMMARY OF THE INVENTION

Since restaurants lack experienced chefs, causing instability of food quality, the present invention provides a chef robot device, and the chef robot device includes a temperature sensing module, an image recognizing module, an odor detecting module, a central processing unit (CPU), and a robotic arm module.

The temperature sensing module senses a real time temperature in a cooker to output a temperature sensing signal.

The image recognizing module captures a real time image inside the cooker to recognize the real time image for determining a food color depth of a food in the cooker, and outputs a food color depth signal according to the food color depth.

The odor detecting module detects an environmental odor around the cooker to recognize a specific odor, and outputs an odor concentration signal according to a specific odor concentration.

The CPU is electrically connected to the temperature sensing module, the image recognizing module, and the odor detecting module for receiving the temperature sensing signal, the food color depth signal, and the odor concentration signal. The CPU further stores a trajectory planning model, and outputs multiple motion instructions according to the trajectory planning model.

The robotic arm module is electrically connected to the CPU for receiving the multiple motion instructions, and performs multiple motions according to the multiple motion instructions.

When the real time temperature is greater than or equal to a start cooking temperature, the CPU controls the robotic arm module to add foods into the cooker and to stir-fry the foods.

When the real time temperature is greater than or equal to a finish cooking temperature, when the food color depth is greater than or equal to a finish cooking color depth, and when the specific odor concentration is greater than or equal to an odor detection threshold, the CPU controls the robotic arm module to take out the foods from the cooker.

When the chef robot device prepares a meal, the CPU can determine a food temperature, a food color, and a food odor according to the temperature sensing signal, the food color depth signal, and the odor concentration signal. The CPU can further output the motion instructions to the robotic arm module according to the food temperature, the food color, the food odor, and the trajectory planning model, such that the robotic arm module can execute the motions according to the multiple motion instructions. Then, processes for preparing the meal can be completed. Moreover, the trajectory planning model can be trained to simulate a professional human chef Namely, the trajectory planning model can be continuously revised and updated by training, and the CPU can control the robotic arm module to more match motions of the professional human chef according to the trajectory planning model. Therefore, the chef robot device can improve stability of preparing various foods, and can resolve a problem of lacking experienced chefs.

### BRIEF DESCRIPTION OF THE DRAWINGS

FIG. 1 is a plan schematic diagram of a chef robot device of the present invention.

FIG. 2 is a stereo schematic diagram of the chef robot device of the present invention.

FIG. 3 is a circuit block diagram of the chef robot device of the present invention.

FIG. 4 is a flowchart for cooking food by the chef robot device of the present invention.

### DETAILED DESCRIPTION OF THE INVENTION

In order to understand and realize technical features and practical effects of the present invention in detail, the detailed description is as follows with embodiments shown in the figures.

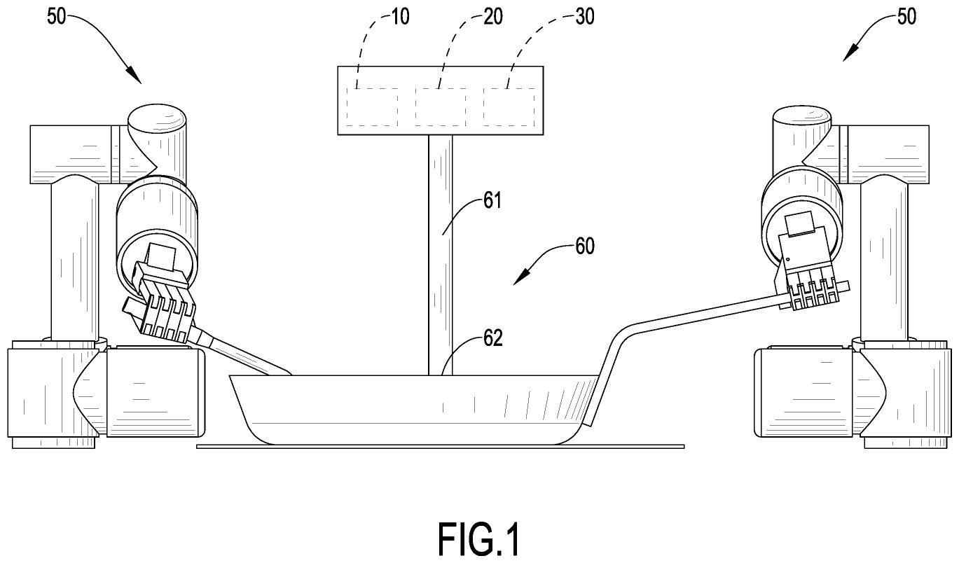

With reference to FIGS. 1 to 3, the present invention is a chef robot device, and the chef robot device includes a temperature sensing module 10, an image recognizing module 20, an odor detecting module 30, a central processing unit (CPU) 40, and a robotic arm module 50.

The temperature sensing module 10 is mounted near a cooker 60, and the temperature sensing module 10 senses a real time temperature in the cooker 60 to output a temperature sensing signal S1. In one embodiment, the temperature sensing module 10 may be a contact temperature sensor, such as a thermocouple sensor. The temperature sensing module 10 may further be mounted in the cooker 60. For example, the cooker 60 may be a wok including a wok body and a wok handle. The temperature sensing module 60 may be mounted at a connection portion between the wok body and the wok handle. When the cooker 60 is heated, the real time temperature in the cooker 60 can be conducted to the whole wok. Therefore, the temperature sensing module 10 can sense the real time temperature in the cooker 60 according to a temperature of the connection portion between the wok body and the wok handle.

In another embodiment, the temperature sensing module 10 may be a contactless temperature sensor, such as a thermal imaging camera. The temperature sensing module 10 can be mounted above an opening 62 of the cooker 60 through a stand 61. Then, the temperature sensing module 10 can detect the real time temperature in the cooker 60 through the opening 62, and can output a thermal image of the cooker 60. In this embodiment, the thermal image is the temperature sensing signal S1. The temperature sensing module 10 shown in FIG. 1 is a contactless temperature sensor.

The image recognizing module 20 is adjacently mounted above the cooker 60. The image recognizing module 20 captures a real time image inside the cooker 60, and recognizes a food color depth of a food in the cooker 60 to output a food color depth signal S2 according to the food color depth. With reference to FIG. 1, the image recognizing module 20 can also be mounted above the opening 62 of the cooker 60 through the stand 61 to capture the real time image inside the cooker 60.

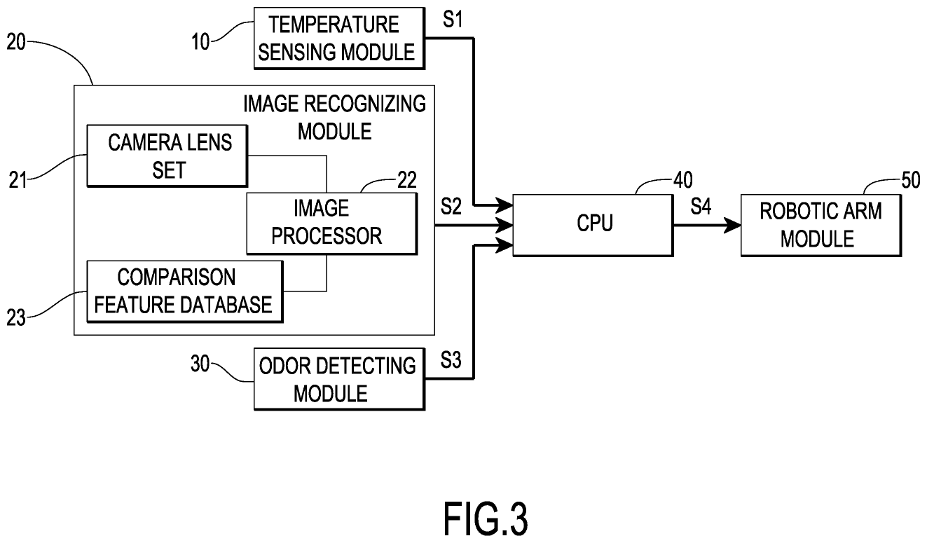

With reference to FIG. 3, the image recognizing module 20 can further include a camera lens set 21, an image processor 22, and a comparison feature database 23. The camera lens set 21 faces to the opening 62 to capture the real time image inside the cooker 60. The image processor 22 is electrically connected to the camera lens set 21 and the comparison feature database 23. The comparison feature database 23 stores multiple comparison features. The image processor 22 can process and recognize the real time image.

Image processing and image recognition are conventional knowledge in the field of the present invention. For example, when the image recognizing module 20 is trained, a developer can take multiple comparison images of various foods in the cooker 60 by the camera lens set 21. The image processor 22 processes the comparison images to extract the comparison features of the comparison images, and stores the comparison features into the comparison feature database 23. After repeatedly training the image recognizing module 20, the image recognizing module 20 will have an ability to recognize the food in the cooker 60. When the camera lens set 21 captures the real time image inside the cooker 60, the image processor 22 recognizes the real time image to extract multiple image features of the real time image. Then, the image processor 22 compares the image features of the real time image with the comparison features stored in the comparison feature data base 23 to recognize the food. For example, the image processor 22 may recognize a color, a type, or a size of the food.

The odor detecting module 30 is mounted near the cooker 60. The odor detecting module 30 detects an environmental odor around the cooker 60 to recognize a specific odor, and output an odor concentration signal S3 according to a specific odor concentration. Specifically, when the food in the cooker 60 is heated, components of the food, such as starch, protein, etc., will undergo a chemical reaction and generate an odor after being heated. For example, the chemical reaction may be the Mena reaction. The odor detecting module 30 can detect the environmental odor to recognize the specific odor. The specific odor may be a burnt odor or “Wok hei”. “Wok hei” is a Cantonese phrase, which refers to the distinct charred, smoky flavor resulting from stir-frying foods over an open flame in Cantonese cuisine. For example, the odor detecting module 30 may be a resistive electronic nose, a piezoelectric electronic nose, a field effect electronic nose, or an optical electronic nose.

Since odor molecules move in the air through diffusion, the closer a position is near an odor source, the higher an odor concentration is. Therefore, in order to improve a detecting ability of the odor detecting module 30, preferably, as shown in FIG. 1, the odor detecting module 30 can also be mounted above the opening 62 of the cooker 60 through the stand 61. When the foods are heated and generate the odor, the odor detecting module 30 can quickly detect the specific odor, and a heating status of the foods can be reflected through the specific odor.

How the odor detecting module 30 recognizes the specific odor is conventional knowledge in the field of the present invention. For example, the odor detecting module 30 may be a resistive electronic nose. In this example, the odor detecting module 30 includes a detecting chip, and a surface of the detecting chip is coated with a polymer material. The polymer material has a special electronic configuration and is conductive. When odor molecules of a testing odor contact the polymer material, the polymer material may expand or contract due to chemical reactions, and a conductive path of the polymer material may be changed, thereby changing a resistance of the polymer material. Different odor types and different odor concentrations will cause the polymer material to produce different resistances. Then, the resistance of the polymer material can be compared with data stored in a database for processing and analyzing, and a pattern or an electronic fingerprint of the testing odor can be generated to identify the odor type and the odor concentration of the testing odor.

With reference to FIG. 3, the CPU 40 is electrically connected to the temperature sensing module 10, the image recognizing module 20, and the odor detecting module 30, for respectively receiving the temperature sensing signal S1, the food color depth signal S2, and the odor concentration signal S3. The CPU 40 further stores a trajectory planning model, and outputs multiple motion instructions S4 according to the trajectory planning model. For example, the CPU 40 includes electronical components, such as a micro processing unit and at least one memory. The CPU is used as a data processing core of the chef robot device. Further, how to train the trajectory planning model with the robotic arm module 50 will be described as follows.

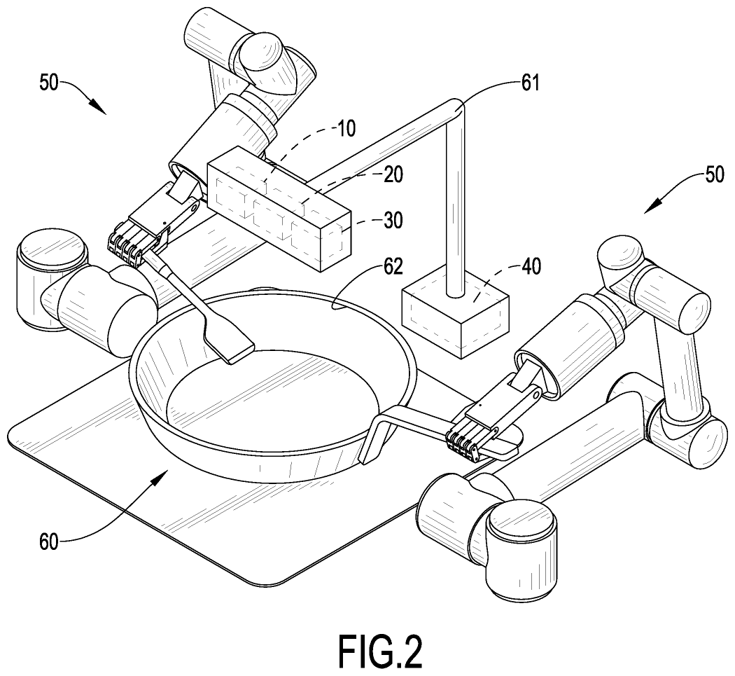

The robotic arm module 50 is electrically connected to the CPU 40 for receiving the motion instructions S4, and performs multiple motions according to the motion instructions S4. For example, the motions include multiple controlling motions and multiple cooking motions. The controlling motions include motions of raising/lowering heating power of the cooker 60. The cooking motions include motions of taking out the foods from the cooker 60. As shown in FIGS. 1 and 2, taking motions “flipping” and/or “stir-frying” for an example, the robotic arm module 50 includes two robotic arms, and the cooker 60 includes a wok body and a wok handle. Each robotic arm includes a palm and five fingers. Namely, the robotic arms may have prosthetic hands, such that the robotic arms can grasp the wok handle to flip the wok body. The motion instructions S4 can instruct one of the two robotic arms to grasp the wok handle and instruct another of the two robotic arms to grasp a wok spatula, and the motion instructions S4 can further instruct the two robotic arms to flip the wok body and to wave the wok spatula for stir-frying the foods (not shown) in the cooker 60.

Regarding how to train the robotic arm module 50 to perform the controlling motions and the cooking motions, a developer respectively wears smart gloves on a left hand and a right hand of a professional, such as a chef, at a training stage. The smart gloves include multiple sensors, such as positioners. Therefore, the smart gloves can sense the motions of the left hand and the right hand of the professional human chef, such as gripping motions, gripping strength, and other information. Then, the developer uses a recording device, such as a training camera or a sensing device, to record three-dimensional motion tracks of the sensors of the smart gloves in a three-dimensional space. The three-dimensional motion tracks are further inputted into the trajectory planning model of the CPU 40, and the trajectory planning model analyzes and processes the three-dimensional motion tracks. Analyzing and processing the three-dimensional motion tracks is a conventional knowledge in the field of the present invention. After the trajectory planning model analyzes and processes the three-dimensional motion tracks, the trajectory planning model outputs the motion instructions S4 corresponding to a cooking process, such as flipping and/or stir-frying, to the robotic arm module 50. The robotic arm module 50 can simulate the motions of the professional human chef according to the motion instructions S4, and the trajectory planning model can further be modified according to the motions performed by the robotic arm module 50.

After repeating the above-mentioned processes, the motion instructions S4 outputted by the trajectory planning model can be more accurate. Then, the motions performed by the robotic arm module 50 can be more similar to the motion of the professional human chef Preferably, for example, the professional human chef may not only use his hands to perform the flipping motions and/or the stir-frying motions, but may also use his upper and lower arms when performing the flipping motions and/or the stir-frying motions. Therefore, when the developer trains the robotic arm module 50, in addition to the smart gloves, the developer may further mount smart kits on the upper arms, the lower arms, and elbows of the professional human chef. The smart kits may include multiple sensors, such as positioners, to completely record the three-dimensional motions of the hands and the arms of the professional human chef.

Moreover, when the robotic arm module 50 is trained to learn the motions of the professional human chef, the temperature sensing module 10, the image recognizing module 20, and the odor detecting module 30 all sense the real time temperatures, the real time images, and the odor concentrations of the cooker 60 while the professional human chef is cooking the meal. The CPU 40 further correspondingly records the real time temperatures, the real time images, and the odor concentrations as multiple thresholds. When the chef robot device cooks the meal, the CPU 40 can determine whether statuses of the foods in the cooker are same as statuses of the foods cooked by the professional human chef according to the multiple thresholds. For example, the CPU 40 records a start cooking temperature. The start cooking temperature is set according to the real time temperature of the cooker 60 when the professional human chef starts cooking the foods. The CPU 40 correspondingly sets different start cooking temperatures for different foods.

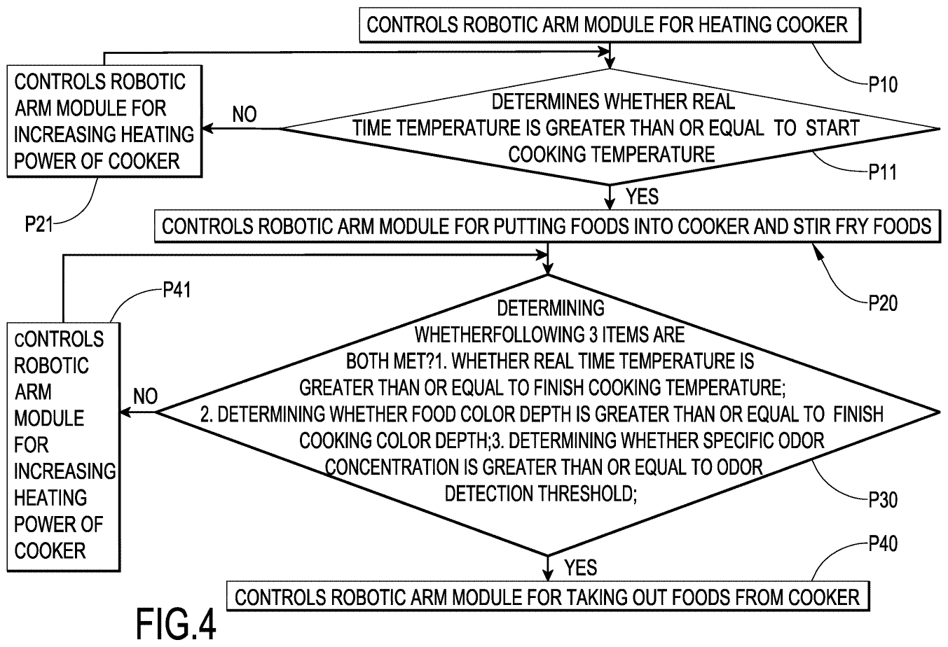

In order to more specifically describe the chef robot device of the present invention, FIG. 4 shows a flowchart for cooking the foods by the chef robot device. Steps of determining and controlling in the flowchart are executed by the CPU 40.

Step P10: the CPU 40 controls the robotic arm module 50 to perform the controlling motions for heating the cooker 60, and the real time temperature of the cooker 60 is raised.

Step P11: the CPU 40 determines whether the real time temperature is greater than or equal to the start cooking temperature according to the temperature sensing signal S1. The start cooking temperature is stored in the CPU 40. When the real time temperature is greater than or equal to the start cooking temperature, the foods can be placed into the cooker 60. When the real time temperature is lower than the start cooking temperature, the foods cannot be placed into the cooker because the real time temperature is not high enough.

Step P20: when the real time temperature is greater than or equal to the start cooking temperature, the CPU 40 controls the robotic arm module 50 to perform the cooking motions for putting the foods into the cooker 60, and for flipping the wok body and/or stir-frying the foods in the cooker 60.

Step P21: when the real time temperature is lower than the start cooking temperature, the CPU 40 increases heating efficiency of the cooker 60. Specifically, the CPU 40 controls the robotic arm module 50 to perform the controlling motions for raising heating power of the cooker 60. For example, when the cooker 60 is heated by a gas stove, the controlling motions include motions for turning a knob of the gas stove. When the cooker 60 is an electromagnetic oven, the controlling motions include motions for pressing buttons of the electromagnetic oven.

Step P30: the CPU 40 determines the following 3 items according to the temperature sensing signal S1, the food color depth signal S2, and the odor concentration signal S3.
1. determining whether the real time temperature is greater than or equal to a finish cooking temperature;
2. determining whether the food color depth is greater than or equal to a finish cooking color depth;
3. determining whether the specific odor concentration is greater than or equal to an odor detection threshold;

When the above mentioned 3 items are both met, the foods in the cooker 60 are fully heated, surface colors of the foods in the cooker 60 reach standards for cooking, and the foods in the cooker 60 have a burnt aroma due to heating. However, when the above mentioned 3 items are not both met, the foods in the cooker 60 still do not reach the standards for cooking. The finish cooking temperature, the finish cooking color depth, and the odor detection threshold are all stored in the CPU 40. Preferably, the finish cooking temperature is greater than the start cooking temperature. Methods for setting the finish cooking temperature, the finish cooking color depth, and the odor detection threshold are the same as a method for setting the start cooking temperature mentioned above.

Moreover, there are multiple determining steps (not shown) between step P20 and step P30 for determining whether temperatures for cooking the foods are appropriate. For example, the multiple determining steps include the following steps.

When the real time temperature is greater than or equal to the start cooking temperature, the CPU 40 periodically determines whether the real time temperature is greater than a temperature setting value every preset time period.

When the real time temperature is lower than the temperature setting value, the CPU 40 controls the robotic arm module 50 to raise the heating power of the cooker 60. Corresponding to an actual cooking process, the real time temperature being lower than the temperature setting value means that the professional human chef determines the heating power for flipping the wok body and/or stir-frying the foods is insufficient, and then the professional human chef needs to raise the heating power.

When the real time temperature is greater than the temperature setting value, the CPU 40 controls the robotic arm module 50 to lower the heating power of the cooker 60. Corresponding to an actual cooking process, the real time temperature being greater than the temperature setting value means that the professional human chef needs to lower the heating power for stewing the foods.

The preset time period can be adjusted according to the type of the food. For example, when the food is easily overcooked, the start cooking temperature can be set to 50° C., the preset time period can be set to 15 seconds, and the temperature setting value can be set to 85° C. Namely, when the robotic arm module 50 flips the wok body or stir-fries the foods, the CPU 40 determines whether the real time temperature of the cooker 60 is suitable for flipping and/or stir-frying every 15 seconds. When the real time temperature is not suitable for flipping the wok body and/or stir-frying the food, the robotic arm module 50 can correspondingly increase or lower the heating power of the cooker 60.

Step P40: when the real time temperature is greater than or equal to the finish cooking temperature, when the food color depth is greater than or equal to the finish cooking color depth, and when the specific odor concentration is greater than or equal to the odor detection threshold, the CPU 40 controls the robotic arm module 50 to perform the cooking motions for taking out the foods from the cooker 60.

In one embodiment of the present invention, before the robotic arm module 50 takes out the food from the cooker 60, the robotic arm module 50 further performs the cooking motions to add at least one seasoning into the cooker 60 for seasoning the foods. In another embodiment, before the robotic arm module 50 takes out the food from the cooker 60, the robotic arm module 50 further performs the controlling motions to stop heating the cooker 60.

Step P41: when the real time temperature is lower than the finish cooking temperature, when the food color depth is lower than the finish cooking color depth, or when the specific odor concentration is lower than the odor detection threshold, the CPU 40 controls the robotic arm module 50 to perform the controlling motions for increasing the heating power of the cooker 60.

Further, in one embodiment of the present invention, when specific odor concentration is greater than or equal to an odor concentration upper threshold, the foods in the cooker 60 may be overcooked or burnt. The CPU 40 can further determine the foods in the cooker 60 are overcooked or burnt according to the food color depth. For example, when the food color depth of the foods in the cooker 60 is lower than a preset color depth, the foods in the cooker 60 may be overcooked. Then, the CPU 40 controls the robotic arm module 50 to lower the heating power of the cooker 60. When the food color depth of the foods in the cooker 60 is greater than the preset color depth, the foods in the cooker 60 may be burnt. Then, the CPU 40 controls the robotic arm module 50 to take out the foods in the cooker 60.

The chef robot device of the present invent can sense temperatures, color depths, and odors of the foods in the cooker 60 by using the temperature sensing module 10, the image recognizing module 20, and the odor detecting module 30. Then, the temperature sensing signal S1, the food color depth signal S2, and the odor concentration signal S3 are transmitted to the CPU 40. The CPU 40 stores the trajectory planning model. Therefore, the CPU 40 can output the motion instructions S4 to the robotic arm module 50 according to the trajectory planning model. The robotic arm module 50 performs the controlling motions and the cooking motions according to the motion instructions S4. When the chef robot device cooks the food, the CPU 40 can output different motion instructions S4 according to the temperature sensing signal S1, the food color depth signal S2, and the odor concentration signal S3, and the robotic arm module 50 can finish cooking the food according to the motion instructions S4. Moreover, the robotic arm module 50 can be trained to simulate the professional human chef Namely, the trajectory planning model can be continuously modified and updated by training, and the CPU 40 can control the robotic arm module 50 to more match motions of the professional human chef according to the trajectory planning model. Therefore, the chef robot device can improve stability of preparing various foods, and can resolve a problem of lack of experienced chefs.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A chef robot device, comprising:
a temperature sensing module, sensing a real time temperature in a cooker to output a temperature sensing signal;
an image recognizing module, capturing a real time image inside the cooker to recognize the real time image for determining a food color depth of a food in the cooker, and outputting a food color depth signal according to the food color depth;
an odor detecting module, detecting an environmental odor around the cooker to recognize a specific odor, and outputting an odor concentration signal according to a specific odor concentration;
a central processing unit (CPU), electrically connected to the temperature sensing module, the image recognizing module, and the odor detecting module for receiving the temperature sensing signal, the food color depth signal, and the odor concentration signal; wherein the CPU further stores a trajectory planning model, and outputs multiple motion instructions according to the trajectory planning model;
a robotic arm module, electrically connected to the CPU for receiving the multiple motion instructions, and performing multiple motions according to the multiple motion instructions;
wherein when the real time temperature is greater than or equal to a start cooking temperature, the CPU controls the robotic arm module to add foods into the cooker and to flip the wok body or stir-fry the foods;
wherein when the real time temperature is greater than or equal to a finish cooking temperature, when the food color depth is greater than or equal to a finish cooking color depth, and when the specific odor concentration is greater than or equal to an odor detection threshold, the CPU controls the robotic arm module to take out the foods from the cooker.

2. The chef robot device as claimed in claim 1, wherein when the real time temperature is greater than or equal to the start cooking temperature, the CPU periodically determines whether the real time temperature is greater than a temperature setting value every preset time period; and
wherein when the real time temperature is lower than the temperature setting value, the CPU controls the robotic arm module to raise a heating power of the cooker.

3. The chef robot device as claimed in claim 1, wherein when the real time temperature is greater than or equal to the start cooking temperature, the CPU periodically determines whether the real time temperature is greater than a temperature setting value every preset time period; and
wherein when the real time temperature is greater than the temperature setting value, the CPU controls the robotic arm module to lower a heating power of the cooker.

4. The chef robot device as claimed in claim 1, wherein when the real time temperature is lower than the start cooking temperature, the CPU controls the robotic arm module to heat the cooker.

5. The chef robot device as claimed in claim 1, wherein when specific odor concentration is greater than or equal to an odor concentration upper threshold and when the food color depth of the foods in the cooker is lower than a preset color depth, the CPU controls the robotic arm module to lower the heating power of the cooker.

6. The chef robot device as claimed in claim 1, wherein when the specific odor concentration is greater than or equal to an odor concentration upper threshold and when the food color depth of the foods in the cooker is greater than a preset color depth, the CPU controls the robotic arm module to take out the foods from the cooker.

7. The chef robot device as claimed in claim 1, wherein the image recognizing module comprises a camera lens set, an image processor, and a comparison feature database; wherein the camera lens set captures the real time image inside the cooker, the image processor is electrically connected to the camera lens set and the comparison feature database, and the comparison feature database stores multiple comparison features;
wherein when the image recognizing module recognizes the real time image, the image processor extracts the comparison features of the real time image, and compares the image features of the real time image with the comparison features stored in the comparison feature data base to determine the food color depth of the foods.

8. The chef robot device as claimed in claim 1, wherein before the robotic arm module takes out the food from the cooker, the CPU further controls the robotic arm module to perform the motions for adding at least one seasoning into the cooker, and for stopping heating the cooker.

9. The chef robot device as claimed in claim 1, wherein when the robotic arm module is trained, smart gloves are worn on a left hand and a right hand of a professional human chef, and wherein a recording device records three-dimensional motion tracks of the smart gloves in a three-dimensional space, and inputs the three-dimensional motion tracks into the trajectory planning model.

10. The chef robot device as claimed in claim 1, wherein when the real time temperature is lower than the finish cooking temperature, when the food color depth is lower than the finish cooking color depth, or when the specific odor concentration is lower than the odor detection threshold, the CPU controls the robotic arm module to perform the motions for increasing the heating power of the cooker.
